(19) United States
(12) Patent Application Publication
(10) Pub. No.: US 2025/0191467 A1
(43) Pub. Date: Jun. 12, 2025

(54) WIDE-SCALE VEHICLE CONTROL

(71) Applicant: Ford Global Technologies, LLC, Dearborn, MI (US)

(72) Inventors: Di Shen, Dearborn, MI (US); Qi Dai, Novi, MI (US); Suzhou Huang, Ann Arbor, MI (US)

(73) Assignee: Ford Global Technologies, LLC, Dearborn, MI (US)

(21) Appl. No.: 18/533,535

(22) Filed: Dec. 8, 2023

(51) Int. Cl. G08G 1/0967; G08G 1/00; G08G 1/052; H04W 4/42

(52) U.S. Cl. CPC G08G 1/096725; G08G 1/052; G08G 1/096791; G08G 1/22; H04W 4/42

(57) ABSTRACT

A plurality of vehicles can be communicatively coupled with each other. Each vehicle can include a vehicle computer programmed to receive a transmission including non-ego projected control inputs for at least one of the other vehicles, determine ego projected control inputs for the vehicle based on the non-ego projected control inputs, actuate the vehicle according to the ego projected control input paired with a next timestep after a current time, and transmit the ego projected control inputs to at least one of the other vehicles. The transmission originates from the at least one of the other vehicles. The non-ego projected control inputs are paired with respective future timesteps starting at the next timestep. The ego projected control inputs are paired with the respective future timesteps starting at the next timestep.

### BACKGROUND

Advanced driver assistance systems (ADAS) are electronic technologies that assist drivers in driving and parking functions. Examples of ADAS include forward proximity detection, lane-departure detection, blind-spot detection, braking actuation, adaptive cruise control, and lane-keeping assistance systems.

### BRIEF DESCRIPTION OF THE DRAWINGS

FIG. 1 is a block diagram of an example system of vehicles.

FIG. 2 is a diagrammatic top view of an example scenario of the vehicles traveling on a road.

FIG. 3 is a flowchart of an example process for a remote computer to control the vehicles.

FIG. 4 is a flowchart of an example process for a vehicle computer on board one of the vehicles to control that vehicle.

### DETAILED DESCRIPTION

This disclosure pertains to a system for coordinated control of a plurality of vehicles in a manner that can maintain an efficient average speed of the vehicles and that can have a low likelihood of slowdowns, e.g., a low likelihood of “phantom jams.” “Phantom jams” are temporary traffic jams that spontaneously develop due to typical human driving behaviors, i.e., without exogenous causes such as construction zones or lane closures. The system includes a plurality of vehicles communicatively coupled with each other. The vehicles coordinate by transmitting projected control inputs for themselves to the other vehicles. For the purposes of this disclosure, a “control input” is one or more values that control operation of a component of a vehicle. The projected control inputs cover multiple future timesteps. Upon receiving the projected control inputs from at least one other vehicle, each vehicle determines its projected control inputs starting at a next timestep and actuates itself according to the projected control input for the next timestep. This process can repeat at each timestep (meaning that the projected control inputs beyond the next timestep are subject to change). The ability to anticipate actions by other vehicles permits coordination among the vehicles, thereby maintaining an efficient average speed, e.g., a higher average speed than might otherwise result, with a low likelihood of slowdowns. Moreover, the system permits centralized control by a remote computer combined with decentralized processing on board the vehicles. The remote computer may determine a target speed for the vehicles, and the vehicles may determine their projected control inputs based on the target speed along with the projected control inputs from the other vehicles. The decentralized processing may permit the computation to be fast enough for real-time operation.

A computer includes a processor and a memory, and the memory stores instructions executable by the processor to receive a transmission including non-ego projected control inputs for at least one non-ego vehicle, the transmission originating from the at least one non-ego vehicle, the non-ego projected control inputs paired with respective future timesteps starting at a next timestep after a current time; determine ego projected control inputs for an ego vehicle based on the non-ego projected control inputs, the ego vehicle including the computer, the ego projected control inputs paired with the respective future timesteps starting at the next timestep; and actuate the ego vehicle according to the ego projected control input paired with the next timestep.

In an example, instructions may further include instructions to transmit the ego projected control inputs to a server remote from the ego vehicle.

In an example, the instructions may further include instructions to receive a second transmission including second non-ego projected control inputs for the at least one non-ego vehicle, the second non-ego projected control inputs paired with the respective future timesteps starting with a following timestep that is immediately after the next timestep; upon actuating the ego vehicle according to the ego projected control input for the next timestep, determine second ego projected control inputs for the ego vehicle based on the second non-ego projected control inputs, the second ego projected control inputs paired with the respective future timesteps starting at the following timestep; and then actuate the ego vehicle according to the second ego projected control input paired with the following timestep.

In an example, the instructions may further include instructions to refrain from actuating the ego vehicle according to the ego projected control inputs paired with the timesteps after the next timestep.

In an example, the instructions may further include instructions to determine the ego projected control inputs by maximizing a utility function over the future timesteps. In a further example, the instructions may further include instructions to receive a second transmission including an optimal speed, the transmission originating outside the ego vehicle, and the utility function may reward forward motion of the ego vehicle up to the optimal speed.

In another further example, the utility function may penalize reverse motion of the ego vehicle.

In another further example, the utility function may penalize proximity of the ego vehicle to the at least one non-ego vehicle. In a yet further example, the at least one non-ego vehicle may include a single non-ego vehicle traveling immediately forward from the ego vehicle.

In another further example, the instructions may further include instructions to maximize the utility function by performing a grid search over possible ego projected control inputs.

In another further example, the instructions may further include instructions to maximize the utility function by parameterizing the possible ego projected control inputs to a smaller number of variables than the number of ego projected control inputs. In a yet further example, the instructions may further include instructions to parameterize the possible ego projected control inputs by curve-fitting.

In another further example, the instructions may further include instructions to determine a value of the utility function based on projected states of the ego vehicle and the at least one non-ego vehicle at the future timesteps.

In an example, the ego projected control inputs may specify acceleration of the ego vehicle, and the non-ego projected control inputs may specify acceleration of the non-ego vehicle.

A system includes a plurality of vehicles communicatively coupled with each other. Each vehicle includes a vehicle computer programmed to receive a transmission including non-ego projected control inputs for at least one of the other vehicles, the transmission originating from the at least one of the other vehicles, the non-ego projected control inputs paired with respective future timesteps starting at a next timestep after a current time; determine ego projected control inputs for the vehicle based on the non-ego projected control inputs, the ego projected control inputs paired with the respective future timesteps starting at the next timestep; actuate the vehicle according to the ego projected control input paired with the next timestep; and transmit the ego projected control inputs to at least one of the other vehicles.

In an example, the system may further include a remote computer separate from the vehicles and communicatively coupled to the vehicles, and the remote computer may be programmed to determine an optimal speed based on states of the vehicles and transmit the optimal speed to the vehicles. In a further example, each vehicle computer may be programmed to determine the ego projected control inputs based on the optimal speed.

In another further example, the optimal speed may be a target speed for the vehicles that maximizes an average speed of the vehicles.

In another further example, the optimal speed may be a target speed for the vehicles that maximizes an average speed of the vehicles subject to constraining an average of amplitude oscillations of speeds of the vehicles within a preset limit.

A method includes receiving a transmission including non-ego projected control inputs for at least one non-ego vehicle, the transmission originating from the at least one non-ego vehicle, the non-ego projected control inputs paired with respective future timesteps starting at a next timestep after a current time; determining ego projected control inputs for an ego vehicle based on the non-ego projected control inputs, the ego projected control inputs paired with the respective future timesteps starting at the next timestep; actuating the ego vehicle according to the ego projected control input paired with the next timestep; and transmitting the ego projected control inputs to a server remote from the ego vehicle.

With reference to the Figures, wherein like numerals indicate like parts throughout the several views, a system 100 includes a plurality of vehicles 105 communicatively coupled with each other. Each vehicle 105 includes a vehicle computer 110 programmed to receive a transmission including non-ego projected control inputs for at least one of the other vehicles 105, determine ego projected control inputs for the vehicle 105 based on the non-ego projected control inputs, actuate the vehicle 105 according to the ego projected control input paired with a next timestep after a current time, and transmit the ego projected control inputs to at least one of the other vehicles 105. The term “ego” describes something related to the vehicle 105 whose actions are being discussed, and the term “non-ego” refers to the other vehicles 105 besides the ego vehicle 105. The transmission originates from the at least one of the other vehicles 105. The non-ego projected control inputs are paired with respective future timesteps starting at the next timestep. The ego projected control inputs are paired with the respective future timesteps starting at the next timestep.

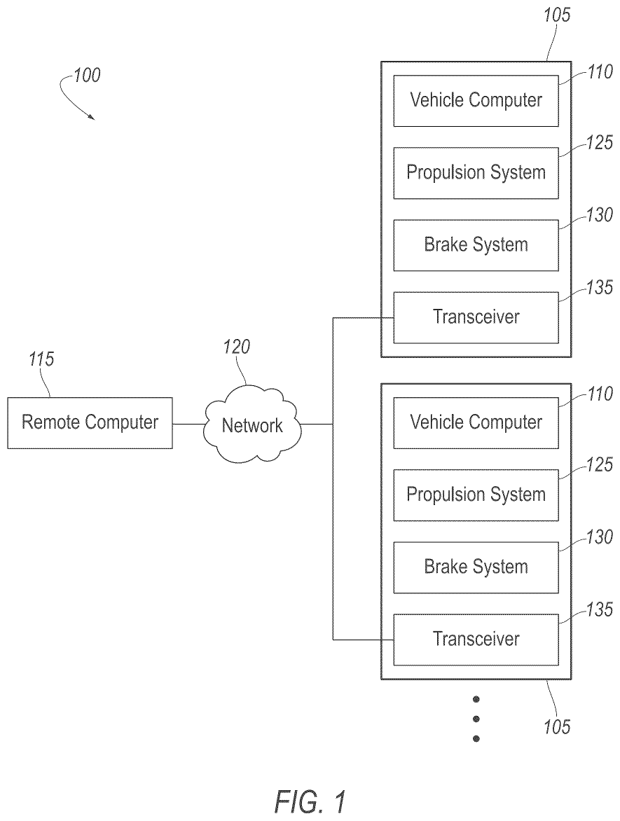

With reference to FIG. 1, the system 100 includes a remote computer 115, a network 120, and a plurality of the vehicles 105. The remote computer 115 and the vehicles 105 are communicatively coupled with each other via the network 120. The remote computer 115 is separate from the vehicles 105. For example, the remote computer 115 may be at a fixed location spaced from the vehicles 105, e.g., as part of an infrastructure component. As described below, the remote computer 115 may provide central coordination for the vehicles 105.

The remote computer 115 is a microprocessor-based computing device, e.g., a generic computing device including a processor and a memory. The memory of the remote computer 115 can include media for storing instructions executable by the processor as well as for electronically storing data and/or databases, and/or the remote computer 115 can include structures such as the foregoing by which programming is provided. The remote computer 115 can be multiple computers coupled together.

The network 120 represents one or more mechanisms by which the remote computer 115 and the vehicles 105 may communicate with each other. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, IEEE 802.11, cellular-V2X (CV2X), Dedicated Short-Range Communications (DSRC), etc.), local area networks (LAN) and/or wide area networks (WAN), including the Internet, providing data communication services.

Each vehicle 105 may be any passenger or commercial automobile such as a car, a truck, a sport utility vehicle, a crossover, a van, a minivan, a taxi, a bus, etc. Each vehicle 105 may include the vehicle computer 110, a propulsion system 125, a brake system 130, and a transceiver 135, along with other systems and components.

The vehicle computer 110 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The vehicle computer 110 can thus include a processor, a memory, etc. The memory of the vehicle computer 110 can include media for storing instructions executable by the processor as well as for electronically storing data and/or databases, and/or the vehicle computer 110 can include structures such as the foregoing by which programming is provided. The vehicle computer 110 can be multiple computers coupled together.

The propulsion system 125 of each vehicle 105 generates energy and translates the energy into motion of the vehicle 105. The propulsion system 125 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion system 125 can include an electronic control unit (ECU) or the like that is in communication with and receives input from the vehicle computer 110 and/or a human operator. The human operator may control the propulsion system 125 via, e.g., an accelerator pedal and/or a gear-shift lever.

The brake system 130 of each vehicle 105 is typically a conventional vehicle braking subsystem and resists the motion of the vehicle 105 to thereby slow and/or stop the vehicle 105. The brake system 130 may include friction brakes such as disc brakes, drum brakes, band brakes, etc.; regenerative brakes; any other suitable type of brakes; or a combination. The brake system 130 can include an electronic control unit (ECU) or the like that is in communication with and receives input from the vehicle computer 110 and/or a human operator. The human operator may control the brake system 130 via, e.g., a brake pedal.

The transceiver 135 of each vehicle 105 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 135 may be adapted to communicate with a remote server, that is, a server distinct and spaced from the vehicle 105. The remote server may be located outside the vehicle 105. For example, the remote server may be associated with another vehicle 105 (e.g., V2V communications), an infrastructure component (e.g., V2I communications with the remote computer 115), an emergency responder, a mobile device associated with the owner of the vehicle 105, etc. The transceiver 135 may be one device or may include a separate transmitter and receiver.

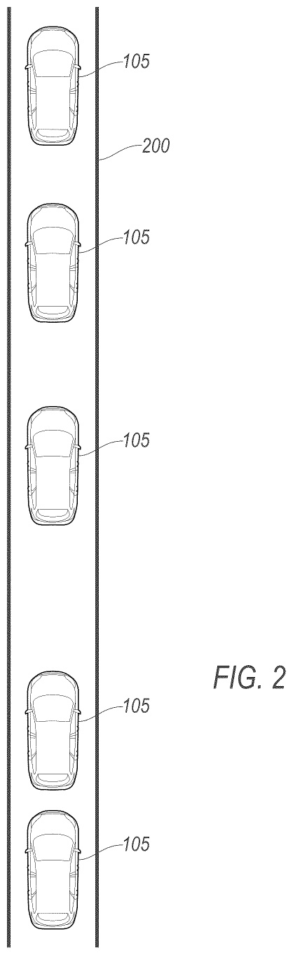

With reference to FIG. 2, the vehicles 105 are traveling on a same road 200 or a same interconnected series of roads 200. In the specific example described herein, the vehicles 105 are traveling the same direction on the same one-lane road 200 or on the same lane of a multilane road 200. The techniques herein may be extended to other scenarios in which the vehicles 105 are interacting.

When describing the programming of one of the vehicle computers 110, the modifier “ego” refers to the vehicle 105 including that specific vehicle computer 110, and the modifier “non-ego” refers to the other vehicles 105, which do not include that specific vehicle computer 110. For ease of description, the programming of a single vehicle computer 110 will be described. The same programming may be implemented on all the vehicle computers 110.

The determinations described below may be performed for a set of future timesteps. The future timesteps are discrete instances in time. The future timesteps may have a uniform length Δt chosen based on a calculation speed of the vehicle computers 110 and a latency in communication between the vehicles 105. The future timesteps may start at a next timestep after a current timestep. The set of future timesteps may define a time horizon, i.e., a maximum length of time from a current time into the future for which the calculations are performed. The time horizon may be defined by a number H of timesteps, meaning that the length of the time horizon is given by HΔt.

The vehicle computer 110 and the remote computer 115 may be programmed to receive or determine kinematic states of one or more of the vehicles 105. For the purposes of this disclosure, a “kinematic state” is defined as a mathematical description of the position and/or motion of an entity. For example, the kinematic state of each vehicle 105 may include a position, a velocity, and an acceleration, e.g., ζ̌_{i,t}={x_{i,t}, v_{i,t}, a_{i,t}}, in which the subscript i is an index value of the vehicle 105, the subscript t is a value of the timestep, x is the position, v is the velocity, and a is the acceleration. For a one-lane road 200, the position x, the velocity v, and the acceleration a may be one-dimensional, i.e., scalar, with positive values indicating the direction of forward travel on the road 200 and negative values indicating the direction of rearward travel on the road 200.

The vehicle computer 110 is programmed to actuate the ego vehicle 105 according to a control input u_{i,t}. For the purposes of this disclosure, a “control input” is one or more values that control operation of a component of a vehicle 105. For example, the vehicle computer 110 may actuate the propulsion system 125 and/or the brake system 130 of the ego vehicle 105 according to the control input u_{i,t}. The control input u_{i,t} may specify acceleration of the ego vehicle 105. Actuating the propulsion system 125 according to the control input can include, for positive values of the control input u_{i,t}, engaging a throttle to match the acceleration a_{i,t} of the ego vehicle 105 to the control input u_{i,t}. Actuating the brake system 130 according to the control input can include, for negative values of the control input u_{i,t}, engaging the brake system 130 so that the acceleration a_{i,t} of the vehicle 105 matches the control input u_{i,t}.

The vehicle computer 110 and the remote computer 115 may be programmed to determine a projected kinematic state of one or more of the vehicles 105 at a future timestep. The vehicle computer 110 or remote computer 115 may execute a physics-based model of the vehicle 105 based on the kinematic state of the vehicle 105 at the previous timestep and the projected control inputs to the vehicle 105. For example, the position of the vehicle 105 at a future timestep may be a sum of the position at the immediately previous timestep and a product of the velocity at the immediately previous timestep and the length of a timestep. The position may be calculated with a preset modulo, which in effect models the single-lane road 200 as a ring with a circumference equal to the modulo. A ring model can simplify calculations through future timesteps with no loss of accuracy. The velocity of the vehicle 105 at a future timestep may be a sum of the velocity at the immediately previous timestep and a product of the acceleration at the immediately previous timestep and the length of a timestep. The acceleration may be weighted between the acceleration at the previous timestep, the control input at the previous timestep, and the control input at the second most recent timestep. The computer may determine the projected kinematic state at the future timestep iteratively, e.g., starting from a current timestep and determining each timestep up to the future timestep, e.g., as in the following set of expressions:

$$\begin{matrix}{x}_{i , t + 1} = {x}_{i , t} + {v}_{i , t} Δ t + {μ}_{i , t + 1}^{x} , ( mod C ) \\ {v}_{i , t + 1} = {v}_{i , t} + {a}_{i , t} Δ t + {μ}_{i , t + 1}^{v} \\ {a}_{i , t + 1} = γ {a}_{i , t} + ( {u}_{i , t} - γ {u}_{i , t - 1} ) + {μ}_{i , t + 1}^{a}\end{matrix}$$

in which μ indicates a noise term, C is the modulo, γ is the weight for the acceleration, and ū is the projected control input. The modulo C may be chosen to be sufficiently large to encompass all the vehicles 105. The weight γ may be a preset value chosen based on how reactive the propulsion system 125 and brake system 130 typically are. For a non-ego vehicle 105, the projected control inputs may be received in a transmission originating from the vehicle 105 of interest, either directly or via the remote computer 115. For an ego vehicle 105, the projected control inputs may be determined as described below.

The remote computer 115 may be programmed to determine one or more aggregate values characterizing the vehicles 105 as a group. For example, the remote computer 115 may be programmed to determine an average speed of the vehicles 105, e.g., a mean of the projected velocities of the vehicles 105 over the time horizon, as in the following expression:

V≡mean_{i,t}(v_{i,t})

in which meansₖ( ) is the mean of the argument over the variables in the subscript k. The computer may determine the projected velocities for each vehicle 105 iteratively based on the current kinematic state for that vehicle 105 and the projected control inputs received from that vehicle 105, as described above. For another example, the remote computer 115 may be programmed to determine an average of amplitude oscillations of speeds of the vehicles 105, e.g., a mean over time of the difference in velocity between the fastest vehicle 105 and the slowest vehicle 105, as in the following expression:

$$A ≡ {mean}_{t} ( {max}_{i} {v}_{i , t} - {min}_{i} {v}_{i , t} )$$

in which

$${max}_{i} ( )$$

is the maximum value of the argument achieved by varying i, and

$${min}_{i} ( )$$

is the minimum value of the argument achieved by varying i.

The vehicles 105 may be coordinated with a target speed that is common to the vehicles 105. The target speed is a speed at which the vehicles 105 attempt to travel, subject to constraints such as proximity to other vehicles 105. The remote computer 115 may set the target speed at an optimal speed. The optimal speed is the target speed for the vehicles 105 that maximizes the average speed of the vehicles 105 subject to constraining the average of amplitude oscillations of speeds of the vehicles 105 within a preset limit, e.g., as given in the following expression:

$${v}_{opt}^{*} ≡ arg {max}_{{v}^{*}} V {\vert}_{A \leq K}$$

in which vₒₚₜ* is the optimal speed, v* is the target speed, and K is the preset limit. The preset limit K may be chosen to minimize a likelihood of phantom jams. For example, the preset limit K may be zero.

The remote computer 115 may be programmed to determine the optimal speed based on the kinematic states of the vehicles 105. For example, the remote computer 115 may execute an optimization algorithm to find the target speed resulting in the greatest average speed over the projected velocities over the time horizon, starting with the kinematic states of the vehicles 105 at the current timestep. For faster computation, the remote computer 115 may be preloaded with a plurality of scenarios and corresponding optimal speeds, and the computer may select the optimal speed corresponding to the preloaded scenario most closely matching the current kinematic states of the vehicles 105. The preloaded scenarios may be varied in terms of density and distribution of the vehicles 105. The density may be in units of number of vehicles 105 per linear distance along the road 200. The distribution may be a measure of how evenly or unevenly the vehicles 105 are distributed along the road 200. The corresponding optimal speeds may be determined in advance by executing an optimization algorithm for each scenario. Because the calculations are performed ahead of time, the computation time for each preloaded scenario may be significantly longer than one timestep.

The remote computer 115 may be programmed to transmit the optimal speed to the vehicles 105, e.g., to transmit a transmission including the optimal speed to the vehicles 105. The transmission may include additional data along with the optimal speed. The remote computer 115 may determine and transmit the optimal speed at each timestep. The transmission thus originates outside the vehicles 105. The vehicle computer 110 is programmed to receive the transmission including the optimal speed, e.g., via the transceiver 135. The vehicle computer 110 uses the optimal speed to determine the ego projected control inputs, as described below.

Upon receiving the optimal speed, the vehicle computer 110 may be programmed to perform the steps below to determine the ego projected control inputs and actuate the ego vehicle 105 according to the ego projected control input for the next timestep. Alternatively, the remote computer 115 may be programmed to perform the steps below to determine the projected control inputs for the vehicles 105 and actuate the vehicles 105 according to the respective projected control inputs, e.g., by transmitting the respective projected control inputs to the respective vehicles 105. In that case, the remote computer 115 performs the steps in parallel for each vehicle 105.

The vehicle computer 110 or remote computer 115 is programmed to determine a value of a utility function. The form of the utility function is chosen to reward or penalize certain actions by an ego vehicle 105. The utility function may include terms relating to forward motion of the vehicle 105, rearward motion of the vehicle 105, and/or proximity of the vehicle 105 to other vehicles 105, which are described in turn below. The utility function may be a sum over the timesteps of the time horizon of a sum of the terms, e.g., with each term weighted to make the terms commensurable and to express a priority among the terms, e.g., as in the following expression:

$${U}_{i , t}^{eff} = {\sum }_{t = 0}^{H} {\sum }_{k} {w}_{k} {U}_{i , t}^{( k0}$$

in which k is an index of the terms, w is the weight, and U is the term. Parentheses are used to indicate when a variable is a superscript rather than a power. The index k may be 1 for forward motion, 2 for rearward motion, and 3 for proximity to other vehicles 105.

The utility function, e.g., the first term of the utility function, may reward forward motion of the vehicle 105 of interest up to the optimal speed vₒₚₜ*. For example, the first term may include a difference between the velocity v_{i,t} of the vehicle 105 (possibly adjusted to the next timestep using the acceleration a_{i,t}) and the optimal speed vₒₚₜ*. The first term may be an exponential function, i.e., Euler's number e raised to the power of the argument, which can provide greater differentiation as the velocity v_{i,t} of the vehicle 105 and the optimal speed vₒₚₜ* get closer. For example, the first term may be given by the following expression:

$${U}_{i , t}^{( 1 )} = exp ( - {( \frac{{v}_{i , t} + {a}_{i , t} Δ t - {v}_{opt}^{*}}{{κ}_{i}^{( 1 )} {v}_{opt}^{*}} )}^{2} )$$

in which exp( ) is the exponential function, and κᵢ⁽¹⁾ is a scaling term. The weight w₁ for the first term may be a positive value to indicate that forward motion is favored, e.g., 1.

The utility function, e.g., the second term of the utility function, may penalize reverse motion of the ego vehicle 105. For example, the second term may be the exponential function of the negation of the velocity v_{i,t} of the vehicle 105 (possibly adjusted to the next timestep using the acceleration a_{i,t}), e.g., as in the following expression:

$${U}_{i , t}^{( 2 )} = exp ( - {κ}_{v}^{( 2 )} ( {v}_{i , t} + {a}_{i , t} Δ t + {κ}_{0}^{( 2 )} ) )$$

in which κᵥ⁽²⁾ and κ₀⁽²⁾ are scaling or adjustment terms. The weight w₂ for the second term may be a negative value to indicate that reverse motion is disfavored, e.g., −1.

The utility function, e.g., the third term of the utility function, penalizes proximity of the ego vehicle 105 to one of the non-ego vehicles 105, e.g., a non-ego vehicle 105 traveling immediately forward from the ego vehicle 105, which will be referred to as the leading vehicle 105. For example, the third term may be based on a distance between the ego vehicle 105 and the leading vehicle 105, e.g., a bumper-to-bumper distance from the front of the ego vehicle 105 to the rear of the leading vehicle 105. The third term may be based on a ratio between the distance and a function of the velocities of the ego vehicle 105 and the leading vehicle 105. The function of the velocities may increase with the velocity of the ego vehicle 105 and may increase when the ego vehicle 105 is moving closer to the leading vehicle 105, as indicated by their velocities. For example, the third term may be given by the following set of expressions:

$$\begin{matrix}{U}_{i , t}^{( 3 )} = \{ \begin{matrix}1 , & Δ {x}_{i , i + 1 , t} \leq 0 \\ exp ( - {( \frac{Δ {x}_{i , i + 1 , t}}{{δ}_{i , i + 1 , t}} )}^{2} - ( \frac{Δ {x}_{i , i + 1 , t}}{{δ}_{i , i + 1 , t}} ) ) , & Δ {x}_{i , i + 1 , t} > 0\end{matrix} \\ Δ {x}_{i , i + 1 , t} = ( Δ {x}_{i + 1 , t} + Δ {x}_{i + 1 , t} Δ t - {L}_{i + 1} / 2 ) - ( {x}_{i , t} + {v}_{i , t} Δ t - {L}_{i} / 2 ) \\ {δ}_{i , i + 1 , t} = {κ}_{c}^{( 3 )} + {κ}_{v}^{( 3 )} \vert {v}_{i , t} + {a}_{i , t} Δ t \vert + {κ}_{d}^{( 3 )} max ( {v}_{i , t} + {a}_{i , t} Δ t - ( {v}_{i + 1 , t} + {a}_{i + 1 , t} Δ ) , 0 )\end{matrix}$$

in which Δx_{i,j,t} is the bumper-to-bumper distance between the ith and jth vehicles 105 at the tth timestep, δ is the function of the velocities, Li is the length of the ith vehicle 105, and κ_{c}⁽³⁾, κᵥ⁽³⁾, and κ_{d}⁽³⁾ are scaling or adjustment terms. The weight w₃ for the third term may be a negative value to indicate that reverse motion is disfavored and may have a greater magnitude than either of the weights w₁, w₂ to indicate a greater priority for the third term, e.g., −10.

Alternatively, the utility function may be a sum of transforms of the foregoing terms, e.g., with each transformed term weighted as described above, e.g., as in the following expression:

$${U}_{i , t}^{eff} {\sum }_{k} {w}_{k} {g}_{k} ( {U}_{i , t}^{( k )} )$$

in which gₖ is the transform function for the kth term. The transform functions may be chosen to make the predictions closer to typical human operation of the vehicles 105. The transform functions represent the utility for each term over the time horizon, rather than at a single timestep, so the expression above lacks a summation over the timesteps. For example, the respective transform functions g₁, g₂ for the first term and the second term may be the substitution of the projected kinematic states at the next timestep t+1 for the kinematic states at the current timestep t. The transform function g₃ for the third term may be the maximum value for the third term among the future timesteps from the next timestep t+1 for the length of the time horizon t+H+1.

The vehicle computer 110 or remote computer 115 is programmed to determine the ego projected control inputs, i.e., the projected control inputs for the ego vehicle 105, based on the non-ego projected control inputs for at least one non-ego vehicle 105 and based on the optimal speed. The vehicle computer 110 or remote computer 115 determines the ego projected control inputs that maximize the utility function over the future timesteps, e.g., that maximize an aggregation of the values of the utility function at each of the respective future timesteps. Determining the ego projected control inputs is based on the optimal speed, e.g., because the optimal speed is an input to the first term of the utility function. As a general overview, the vehicle computer 110 or remote computer 115 determines the ego projected control inputs that serve as an iterated best response to the non-ego projected control inputs, with “best response” being measured with the utility function. Before the first iteration, the vehicle computer 110 or remote computer 115 initializes the ego projected control inputs and receives the non-ego projected control inputs. At each iteration, first, the vehicle computer 110 or remote computer 115 determines the projected kinematic states of the ego vehicle 105 and the at least one non-ego vehicle 105 based on the ego projected control inputs from the previous iteration (starting with the initialized ego projected control inputs) and based on the non-ego projected control inputs. Next, the vehicle computer 110 or remote computer 115 determines the total value of the utility function based on the projected kinematic states. Finally, the vehicle computer 110 or remote computer 115 updates the ego projected control inputs, e.g., by performing a grid search on a parameterized set of the ego projected control inputs. The vehicle computer 110 or remote computer 115 iteratively performs these steps for a preset number of iterations or until the ego projected control inputs converge. The vehicle computer 110 transmits the ego projected control inputs from the final iteration to the remote computer 115 and/or the non-ego vehicles 105, or the remote computer 115 transmits the respective projected control inputs for the next timestep from the final iteration to the respective vehicles 105. The vehicle computer 110 actuates the ego vehicle 105 according to the ego projected control input for the next timestep from the final iteration. The vehicle computer 110 or remote computer 115 performs the foregoing steps, from initialization to transmission and actuation, at each timestep.

The ego and non-ego projected control inputs are paired with the respective future timesteps starting at the next timestep for the time horizon. In other words, the projected control inputs for each vehicle 105 include one projected control input for each timestep from the next timestep t+1 after the current time t up to the last timestep within the time horizon H, i.e., u_{i,t+h} for h={0, 1, 2, . . . . H}.

The vehicle computer 110 or remote computer 115 is programmed to initialize the ego projected control inputs. For example, the ego projected control inputs may be initialized to preset values. The preset values may be, e.g., the final ego projected control inputs from the previous timestep, or zero.

The vehicle computer 110 is programmed to receive a transmission including the non-ego projected control inputs for at least one non-ego vehicle 105. The transmission of the non-ego projected control inputs for a specific non-ego vehicle 105 originates from that specific non-ego vehicle 105, and the transmission may be transmitted directly from that non-ego vehicle 105 to the ego vehicle 105 or transmitted indirectly via the remote computer 115. For the single-lane implementation, the at least one non-ego vehicle 105 may be the non-ego vehicle 105 directly in front of the ego vehicle 105, i.e., the closest leading non-ego vehicle 105 to the ego vehicle 105. Alternatively, the remote computer 115 receives the projected control inputs from the previous timestep.

The vehicle computer 110 or remote computer 115 is programmed to determine the projected kinematic states for the ego vehicle 105 and for the at least one non-ego vehicle 105 over the time horizon. For the ego vehicle 105, the vehicle computer 110 may determine the ego projected kinematic state at each timestep with the set of equations described above, up to the final timestep in the time horizon and inputting the ego projected control inputs from the previous iteration (starting with the initialized ego projected control inputs) into the set of equations. For the non-ego vehicle 105, the vehicle computer 110 may determine the non-ego projected kinematic state at each timestep with the set of equations described above, up to the final timestep in the time horizon and inputting the received non-ego projected control inputs into the set of equations. Alternatively, the remote computer 115 may determine the projected kinematic state for each vehicle 105 at each timestep with the set of equations described above, up to the final timestep in the time horizon and inputting the respective projected control inputs from the previous iteration (starting with the initialized projected control inputs) into the set of equations.

The vehicle computer 110 or remote computer 115 is programmed to determine a value of the utility function based on the ego projected kinematic states and the non-ego projected kinematic states at the future timesteps. The vehicle computer 110 or remote computer 115 determines the value of the utility function by inputting the ego projected kinematic state and non-ego projected kinematic state for the timesteps into the set of equations above for the utility function, either nontransformed or transformed.

The vehicle computer 110 or remote computer 115 is programmed to update the ego projected control inputs based on the value of the utility function. As a general overview, the vehicle computer 110 may parameterize the ego projected control inputs to a smaller number of variables and perform a grid search. The use of a grid search facilitates the discovery of the global maximum rather than convergence on a local maximum.

The vehicle computer 110 or remote computer 115 may parameterize the ego projected control inputs to a smaller number of variables than the number of ego projected control inputs. The ego projected control inputs include a number of control inputs equal to the number of timesteps to the time horizon, i.e., H+1. In other words, the ego projected control input for each timestep is an independent variable. The parameterization defines the ego projected control inputs in terms of dummy variables. The number of independent dummy variables may be less than the number of ego projected control inputs, e.g., 1 or 2. For example, the vehicle computer 110 or remote computer 115 may parameterize the ego projected control inputs by curve-fitting the ego projected control inputs to a set of monomials with progressive powers of the amount of time to a timestep, which is given by the product of the number of the timestep h and the length of the timestep Δt, e.g., as in the following expression:

$${u}_{i , t + h} ( {u}_{i}^{( 0 : H )} ) = {u}_{i}^{( 0 )} + {u}_{i}^{( 1 )} ( h Δ t ) + {{u}_{i}^{( 2 )} ( h Δ t )}^{2} + … + {{u}_{i}^{( H )} ( h Δ t )}^{H}$$

in which uᵢ^{(h)} are the dummy variables. Then the vehicle computer 110 or remote computer 115 may truncate the expression to the first one or two terms, meaning that the first one or two dummy variables are independent, i.e., uᵢ⁽⁰⁾ or uᵢ⁽⁰⁾ and uᵢ⁽¹⁾. Thus, the maximization of the utility function occurs over one or two independent variables rather than H independent variables.

The vehicle computer 110 or remote computer 115 may perform the grid search over the ego projected control inputs, e.g., by performing the grid search over the independent dummy variables and translating the results using the parameterization definition. A grid search determines outcomes at points defined by discrete values of the independent variable(s), with the points thereby arranged in a grid. In this context, the outcomes are the values of the utility function, and the points are sets of values for the independent dummy variables, i.e., scalar values for uᵢ⁽⁰⁾ or two-dimensional vectors with values for uᵢ⁽⁰⁾ and uᵢ⁽¹⁾. The vehicle computer 110 or remote computer 115 may, for a number of iterations equal to the number of points in the grid, update the ego projected control inputs to match each point in the grid in turn and thereby determine the value for the utility function for each point in the grid. At the next iteration after those iterations, the ego projected control inputs may be set to the point having the greatest value for the utility function over the points of the grid.

The vehicle computer 110 or remote computer 115 may perform iterations as described until a termination condition is satisfied. For example, the termination condition may be that the values for the utility function over the iterations converge, e.g., stay within a small preset range of some value for multiple iterations. For another example, the termination condition may be that the vehicle computer 110 or remote computer 115 has performed a preset number of iterations. For another example, the termination condition may be either convergence or a preset number of iterations, whichever occurs first.

The vehicle computer 110 is programmed to transmit the ego projected control inputs to a server remote from the ego vehicle 105, e.g., the remote computer 115 and/or nearby non-ego vehicles 105, via the transceiver 135. Alternatively, the remote computer 115 is programmed to transmit the respective projected control inputs for the next timestep to the respective vehicles 105, i.e., each vehicle 105 receives the ego projected control input for the next timestep.

The vehicle computer 110 is programmed to, upon determining the ego projected control inputs for the future steps t+1 to H or receiving the ego projected control input for the next timestep t+1, actuate the ego vehicle 105 according to the ego projected control input paired with the next timestep t+1. For example, the vehicle computer 110 may actuate the propulsion system 125 or the brake system 130 to match the acceleration specified in the ego projected control input for the next timestep t+1, as described above.

The vehicle computer 110 is programmed to, upon actuating the ego vehicle 105 according to the ego projected control input for the next timestep t+1, perform the foregoing steps again to determine new ego projected control inputs, e.g., initialize the ego projected control inputs starting at the following timestep t+2 through the time horizon up to H+1, receive a transmission including the non-ego projected control inputs starting at the following timestep t+2 through the time horizon up to H+1, determine the ego projected control inputs starting at the following timestep t+2 through the time horizon up to H+1, and actuate the ego vehicle 105 according to the newly determined ego projected control input for the following timestep t+2. The vehicle computer 110 thus refrains from actuating the ego vehicle 105 according to the previously determined ego projected control inputs for the timesteps after the next timestep t+1. The benefit of the ego projected control inputs beyond the next timestep is coordinating activity with the non-ego vehicles 105 rather than for controlling the ego vehicle 105. Alternatively, the remote computer 115 is programmed to, upon transmitting the ego projected control inputs for the next timestep, perform the foregoing steps again to determine new projected control inputs for all the vehicles 105.

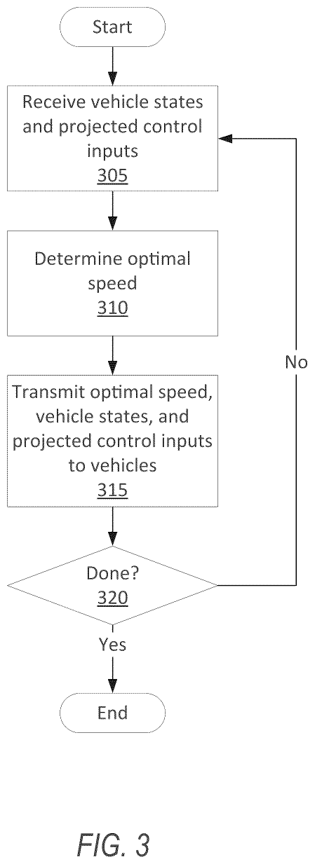

FIG. 3 is a flowchart illustrating an example process 300 for the remote computer 115 to coordinate the activity of the vehicles 105. The memory of the remote computer 115 stores executable instructions for performing the steps of the process 300 and/or programming can be implemented in structures such as mentioned above. As a general overview of the process 300, the remote computer 115 receives the projected control inputs and kinematic states for the vehicles 105, determines the optimal speed, and transmits the optimal speed, kinematic states, and projected control inputs to the vehicles 105.

The process 300 begins in a block 305, in which the remote computer 115 receives a transmission from each vehicle 105 including the projected control inputs and kinematic state for that vehicle 105.

Next, in a block 310, the remote computer 115 determines the optimal speed based on the kinematic states of the vehicles 105, as described above.

Next, in a block 315, the remote computer 115 transmits the optimal speed, the projected control inputs, and the kinematic states to the vehicles 105.

Next, in a decision block 320, the remote computer 115 determines whether some condition for ending the process 300 has occurred, e.g., the remote computer 115 is powering off, the remote computer 115 is updating its software, no vehicles 105 are within range of the remote computer 115, etc. In the absence of such a condition, the process 300 returns to the block 305 at the next timestep to re-determine the optimal speed. Upon such a condition occurring, the process 300 ends.

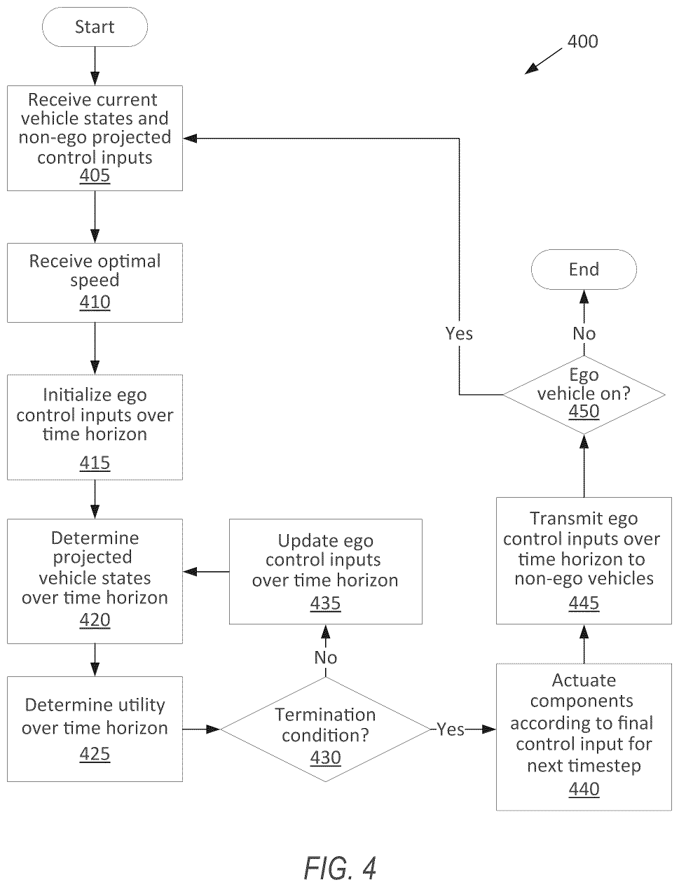

FIG. 4 is a flowchart illustrating an example process 400 for the vehicle computer 110 or remote computer 115 to control the ego vehicle 105 and coordinate with the non-ego vehicles 105. The memory of the vehicle computer 110 and/or remote computer 115 stores executable instructions for performing the steps of the process 400 and/or programming can be implemented in structures such as mentioned above. As a general overview of the process 400, the vehicle computer 110 or remote computer 115 receives the kinematic states and non-ego projected control inputs, receives the optimal speed, and initializes the ego projected control inputs. The vehicle computer 110 or remote computer 115 iteratively determines the projected kinematic states, determines the value of the utility function, and updates the ego projected control inputs, until a termination condition is satisfied. The vehicle computer 110 then actuates the ego vehicle 105 according to the ego projected control input for the next timestep and transmits the ego projected control inputs to the remote computer 115 and non-ego vehicles 105, or the remote computer 115 transmits the ego projected control inputs for the next timestep to each vehicle 105 for actuating that vehicle 105 and stores the projected control inputs to use on the next timestep. The process 400 repeats each timestep for as long as the ego vehicle 105 remains on and in an environment controlled by the remote computer 115.

The process 400 begins in a block 405, in which the vehicle computer 110 receives a transmission including the non-ego projected control inputs and non-ego kinematic state for the non-ego vehicle 105, or the remote computer 115 receives transmissions including the kinematic states for the vehicles 105, as described above.

Next, in a block 410, the vehicle computer 110 receives a transmission including the optimal speed from the remote computer 115, or the remote computer 115 loads the optimal speed as determined above, as described above.

Next, in a block 415, the vehicle computer 110 or remote computer 115 initializes the ego projected control inputs, as described above.

Next, in a block 420, the vehicle computer 110 or remote computer 115 determines the projected kinematic states of the ego vehicle 105 and the non-ego vehicle 105 over the time horizon based on the ego and non-ego kinematic states and the ego and non-ego projected control inputs, as described above. The remote computer 115 determines the projected kinematic states of all the vehicles 105 in parallel.

Next, in a block 425, the vehicle computer 110 or remote computer 115 determines the value of the utility function based on the projected kinematic states over the time horizon, as described above.

Next, in a decision block 430, the vehicle computer 110 or remote computer 115 determines whether a termination condition is satisfied, as described above. In response to the termination condition not being satisfied, the process 400 proceeds to a block 435. In response to the termination condition being satisfied, the process 400 proceeds to a block 440.

In the block 435, the vehicle computer 110 or remote computer 115 updates the ego projected control inputs, as described above. After the block 435, the process 400 returns to the block 420 for the next iteration.

In the block 440, the vehicle computer 110 actuates the ego vehicle 105 according to the ego projected control input paired with the next timestep, as described above. The vehicle computer 110 refrains from actuating the ego vehicle 105 according to the ego projected control inputs paired with the timesteps after the next timestep, as described above. Alternatively, the remote computer 115 transmits the ego projected control inputs paired with the next timestep to each vehicle 105 for the vehicle computer 110 in that vehicle 105 to actuate that vehicle 105.

Next, in a block 445, the vehicle computer 110 instructs the transceiver 135 to transmit the ego projected control inputs and the ego kinematic state to the remote computer 115 and the non-ego vehicles 105, as described above. Alternatively, the remote computer 110 stores the projected control inputs for the vehicles 105 for the next timestep.

Next, in a decision block 450, the vehicle computer 110 or remote computer 115 determines whether the ego vehicle 105 is still operating in an area being coordinated by the remote computer 115. For example, the area may be a specific road 200 or specific lane of a road 200. In response to the ego vehicle 105 still being on and still being in the area coordinated by the remote computer 115, the process 400 returns to the block 405 to determine the ego projected control inputs and actuate the ego vehicle 105 at the next timestep. In response to the vehicle 105 turning off or leaving the area, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
receive a transmission including non-ego projected control inputs for at least one non-ego vehicle, the transmission originating from the at least one non-ego vehicle, the non-ego projected control inputs paired with respective future timesteps starting at a next timestep after a current time;
determine ego projected control inputs for an ego vehicle based on the non-ego projected control inputs, the ego vehicle including the computer, the ego projected control inputs paired with the respective future timesteps starting at the next timestep; and
actuate the ego vehicle according to the ego projected control input paired with the next timestep.

2. The computer of claim 1, wherein the instructions further include instructions to transmit the ego projected control inputs to a server remote from the ego vehicle.

3. The computer of claim 1, wherein the instructions further include instructions to:
receive a second transmission including second non-ego projected control inputs for the at least one non-ego vehicle, the second non-ego projected control inputs paired with the respective future timesteps starting with a following timestep that is immediately after the next timestep;
upon actuating the ego vehicle according to the ego projected control input for the next timestep, determine second ego projected control inputs for the ego vehicle based on the second non-ego projected control inputs, the second ego projected control inputs paired with the respective future timesteps starting at the following timestep; and
then actuate the ego vehicle according to the second ego projected control input paired with the following timestep.

4. The computer of claim 1, wherein the instructions further include instructions to refrain from actuating the ego vehicle according to the ego projected control inputs paired with the timesteps after the next timestep.

5. The computer of claim 1, wherein the instructions further include instructions to determine the ego projected control inputs by maximizing a utility function over the future timesteps.

6. The computer of claim 5, wherein
the instructions further include instructions to receive a second transmission including an optimal speed, the transmission originating outside the ego vehicle; and
the utility function rewards forward motion of the ego vehicle up to the optimal speed.

7. The computer of claim 5, wherein the utility function penalizes reverse motion of the ego vehicle.

8. The computer of claim 5, wherein the utility function penalizes proximity of the ego vehicle to the at least one non-ego vehicle.

9. The computer of claim 8, wherein the at least one non-ego vehicle includes a single non-ego vehicle traveling immediately forward from the ego vehicle.

10. The computer of claim 5, wherein the instructions further include instructions to maximize the utility function by performing a grid search over possible ego projected control inputs.

11. The computer of claim 5, wherein the instructions further include instructions to maximize the utility function by parameterizing possible ego projected control inputs to a smaller number of variables than the number of ego projected control inputs.

12. The computer of claim 11, wherein the instructions further include instructions to parameterize the possible ego projected control inputs by curve-fitting.

13. The computer of claim 5, wherein the instructions further include instructions to determine a value of the utility function based on projected states of the ego vehicle and the at least one non-ego vehicle at the future timesteps.

14. The computer of claim 1, wherein the ego projected control inputs specify acceleration of the ego vehicle, and the non-ego projected control inputs specify acceleration of the non-ego vehicle.

15. A system comprising:
a plurality of vehicles communicatively coupled with each other, wherein each vehicle includes a vehicle computer programmed to:
receive a transmission including non-ego projected control inputs for at least one of the other vehicles, the transmission originating from the at least one of the other vehicles, the non-ego projected control inputs paired with respective future timesteps starting at a next timestep after a current time;
determine ego projected control inputs for the vehicle based on the non-ego projected control inputs, the ego projected control inputs paired with the respective future timesteps starting at the next timestep;
actuate the vehicle according to the ego projected control input paired with the next timestep; and
transmit the ego projected control inputs to at least one of the other vehicles.

16. The system of claim 15, further comprising a remote computer separate from the vehicles and communicatively coupled to the vehicles, the remote computer programmed to:
determine an optimal speed based on states of the vehicles; and
transmit the optimal speed to the vehicles.

17. The system of claim 16, wherein each vehicle computer is programmed to determine the ego projected control inputs based on the optimal speed.

18. The system of claim 16, wherein the optimal speed is a target speed for the vehicles that maximizes an average speed of the vehicles.

19. The system of claim 16, wherein the optimal speed is a target speed for the vehicles that maximizes an average speed of the vehicles subject to constraining an average of amplitude oscillations of speeds of the vehicles within a preset limit.

20. A method comprising:
receiving a transmission including non-ego projected control inputs for at least one non-ego vehicle, the transmission originating from the at least one non-ego vehicle, the non-ego projected control inputs paired with respective future timesteps starting at a next timestep after a current time;
determining ego projected control inputs for an ego vehicle based on the non-ego projected control inputs, the ego projected control inputs paired with the respective future timesteps starting at the next timestep;
actuating the ego vehicle according to the ego projected control input paired with the next timestep; and
transmitting the ego projected control inputs to a server remote from the ego vehicle.
